(19) United States
(12) Patent Application Publication
(10) Pub. No.: US 2025/0281899 A1
(43) Pub. Date: Sep. 11, 2025

(54) METAL-ORGANIC FRAMEWORKS BASED ON UiO-66 AND METHOD FOR DIRECT AIR CAPTURE OF CARBON DIOXIDE

(71) Applicant: KING FAHD UNIVERSITY OF PETROLEUM AND MINERALS, Dhahran (SA)

(72) Inventor: Mahmoud Mohamed Mohamed ABDELNABY, Dhahran (SA)

(73) Assignee: KING FAHD UNIVERSITY OF PETROLEUM AND MINERALS, Dhahran (SA)

(21) Appl. No.: 18/599,411

(22) Filed: Mar. 8, 2024

(51) Int. Cl. B01J 20/22; B01D 53/02; B01J 20/28; B01J 20/30; C07F 19/00

(52) U.S. Cl. CPC B01J 20/226; B01D 53/02; B01J 20/28061; B01J 20/28064; B01J 20/28071; B01J 20/28083; B01J 20/3085; C07F 19/00; B01D 2253/204; B01D 2256/10; B01D 2257/504; B01D 2258/06

(57) ABSTRACT

A metal-organic framework (MOF) material for selective direct air capture of carbon dioxide includes a UiO-66-X MOF. X is covalently bonded to UiO-66. The X may be an aminosilane with one or more primary or secondary amine groups. A method of making the UiO-66-X. A method for capturing carbon dioxide directly from a CO₂ containing gaseous composition.

### STATEMENT REGARDING PRIOR DISCLOSURE BY THE INVENTORS

Aspects of this technology are described in Mahmoud M. Abdelnaby, Islam M. Tayeb, Ahmed M. Alloush, Hussain A. Alyosef, Aljazi Alnoaimi, Mostafa Zeama, Mohammed G. Mohammed, and Sagheer A. Onaizi “Post-synthetic modification of UiO-66 analogue metal-organic framework as potential solid sorbent for direct air capture” published in Journal of CO₂ Utilization, Volume 79, 102647, which is incorporated herein by reference in its entirety.

### STATEMENT OF ACKNOWLEDGEMENT

Support provided by the Interdisciplinary Research Center for Hydrogen and Energy Storage (IRC-HES) at King Fahd University of Petroleum and Minerals (KFUPM) for funding this work through project No INHE2301 is gratefully acknowledged.

### BACKGROUND

### Technical Field

The present disclosure is directed to metal-organic frameworks, particularly to UiO-66-based metal-organic frameworks for direct air capture of carbon dioxide (CO₂).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

With the continuous advancement of technology, the demand for energy is rising to unprecedented levels, leading to a spike in fossil fuel consumption and sharply increasing anthropogenic greenhouse gases in the atmosphere. Notably, carbon dioxide (CO₂) stands out as the most concerning among these gases. The CO₂ concentration in the atmosphere rise from 275-280 ppm in 1750 to around 420 ppm in current times. The atmospheric carbon dioxide concentration is expected to reach 550 ppm by 2050, even with the stabilization of current CO₂ emissions for the next 30 years. These changes result in the rise of global average temperature, alterations in global snow cover, and a decline in the pH levels of the upper ocean. In response to these challenges, the Paris Agreement, endorsed by 196 nations, strives to restrict the increase in global temperature to below 2.0° C. within this century, which has sparked heightened international interest in exploring net negative solutions to address the pressing issue of climate change.

Currently, only one-third of anthropogenic CO₂ emissions originates from point sources, such as power plants based on coal, oil, and natural gas. The rest of the CO₂ emissions result from dispersed and delocalized sources, which makes direct air capture (DAC) an essential and serious CO₂ reduction path. Amongst many technologies being used or developed, separation by solid adsorbents has shown potential as an energy-efficient method for CO₂ removal in industrial processes. Such solid sorbents need to exhibit a plethora of characteristic features, namely stability, re-usability, porosity, versatile surface chemistry, selectivity, minimal regeneration energy requirements, and high loading capacities. Examples of porous materials that may be used in such applications include mesoporous silica, zeolites, carbon-based sorbents, and metal-organic frameworks (MOFs).

Metal-organic frameworks (MOFs) are a class of materials that exhibit versatility in porosity, affinity for specific guest molecules, and chemical composition due to the strong bonds formed between the metallic units and the organic struts. Additionally, MOFs have displayed high crystallinity and ultra-high surface areas, making them suitable for various applications, including gas sequestration and storage. Though MOFs exhibit certain advantageous properties, they still suffer from drawbacks such as low thermal stability, low mechanical properties, and considerable vulnerability to extreme pH environments and molecules such as water oxygen. (See: J. H. Cavka, S. Jakobsen, U. Olsbye, N. Guillou, C. Lamberti, S. Bordiga, K. P. Lillerud, A New Zirconium Inorganic Building Brick Forming Metal Organic Frameworks with Exceptional Stability, J. Am. Chem. Soc. 130 (2008) 13850-13851; Z. Hu, D. Zhao, De facto methodologies toward the synthesis and scale-up production of UiO-66-type metal-organic frameworks and membrane materials, Dalton Trans. 44 (2015) 19018-19040; M. Kim, S. M. Cohen, Discovery, development, and functionalization of Zr(iv)-based metal-organic frameworks, CrystEngComm 14 (2012) 4096-4104).

UiO-66 shows a thermal stability, capable of withstanding temperatures up to 500° C. It also shows a chemical stability against various different polar and organic solvents, such as water, acetone, methanol, benzene, dimethylformamide, and chloroform (See: P. S. Bárcia, D. Guimarães, P. A. P. Mendes, J. A. C. Sil-va, V. Guillerm, H. Chevreau, C. Serre, A. E. Rodrigues, Reverse shape selectivity in the adsorption of hexane and xylene isomers in MOF UiO-66, Microporous, and Mesoporous Materials 139 (2011) 67-73; J. B. DeCoste, G. W. Peterson, B. J. Schindler, K. L. Kil-lops, M. A. Browe, J. J. Mahle, The effect of water adsorption on the structure of the carboxylate containing metal-organic frameworks Cu-BTC, Mg-MOF-74, and UiO-66, J. Mater. Chem. A 1 (2013) 11922-11932). Furthermore, it has demonstrated crystallinity preservation when treated with harsh solutions such as aqueous HCl (pH=1) and aqueous NaOH (pH=14) whilst also maintaining its structural integrity under certain mechanical pressures (See: P. S. Bárcia, D. Guimarães, P. A. P. Mendes, J. A. C. Sil-va, V. Guillerm, H. Chevreau, C. Serre, A. E. Rodrigues, Reverse shape selectivity in the adsorption of hexane and xylene isomers in MOF UiO-66, Microporous and Mesoporous Materials 139 (2011) 67-73; M. Kandiah, M. H. Nilsen, S. Usseglio, S. Jakobsen, U. Olsbye, M. Tilset, C. Larabi, E. A. Quadrelli, F. Bonino, K. P. Lillerud, Synthesis and Stability of Tagged UiO-66 Zr-MOFs, Chem. Mater. 22 (2010) 6632-6640; H. Wu, T. Yildirim, W. Zhou, Exceptional Mechanical Stability of Highly Porous Zirconium Metal-Organic Framework UiO-66 and Its Important Implications, J. Phys. Chem. Lett. 4 (2013) 925-930).

In the case of CO₂ capture and separation, MOFs with polar groups may improve capacity and selectivity against other potential guest molecules (See: G. E. Cmarik, M. Kim, S. M. Cohen, K. S. Walton, Tuning the adsorption properties of UiO-66 via ligand functionalization, Langmuir 28 (2012) 15606-15613; A. Kronast, S. Eckstein, P. T. Altenbuchner, K. Hin-delang, S. I. Vagin, B. Rieger, Gated Channels and Selectivity Tuning of CO₂ over N₂ Sorption by Post-Synthetic Modification of a UiO-66-Type Metal-Organic Framework, Chemistry-A European Journal 22 (2016) 12800-12807).

While studies have shown the possibility of applying MOFs for the purpose of CO₂ capture from flue gas, each of the aforementioned MOFs suffers from one or more drawbacks that hinders their adoption. Hence, there is a need to develop a variant of effectively functionalized UiO-66 for direct air capture of CO₂ to counteract climate change.

In view of the foregoing, it is one objective of the present disclosure to provide a metal-organic framework (MOF) material for selective direct air capture (DAC) of carbon dioxide (CO₂). A second objective of the present disclosure is to provide a method for capturing carbon dioxide directly from a CO₂-containing gaseous composition in the presence of a MOF material. A third objective of the present disclosure is to provide a method of making the MOF material.

### SUMMARY

In an exemplary embodiment, a metal-organic framework (MOF) material for selective direct air capture (DAC) of carbon dioxide (CO₂) is disclosed. The MOF material includes a UiO-66-X MOF. In some embodiments, X is an aminosilane with one or more primary or secondary amine groups. In some embodiments, a molar ratio of UiO-66 to X present in the UiO-66-X MOF is in a range of 1:1 to 1:8.

In some embodiments, X present in the MOF material is of formula (I):

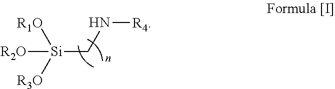

In some embodiments, R₁, R₂, and R₃ are each independently selected from the group consisting of a hydrogen atom, an optionally substituted alkyl, an optionally substituted cycloalkyl, and an optionally substituted alkoxy. In some embodiments, R₄ is selected from the group consisting of a hydrogen atom, an optionally substituted alkyl, an optionally substituted aryl, and a poly(alkylene amino). In some embodiments, n is an integer from 1 to 20.

In another exemplary embodiment, X present in the MOF material is (3-aminopropyl)triethoxysilane (APTES).

In some embodiments, the MOF material has a Brunauer, Emmett and Teller (BET) surface area in a range of 330 to 430 square meter per gram (m²/g).

In some embodiments, the MOF material has a Langmuir surface area in a range of 425 to 525 m²/g.

In some embodiments, the MOF material has an average pore size in a range of 9 to 12 nanometers (nm).

In some embodiments, the MOF material has an average pore volume in a range of 0.05 to 0.2 cubic centimeters per gram (cm³/g).

In some embodiments, the MOF material has a CO₂ uptake of 60 to 70 cm³/g at 270-300 K and 1 bar.

In some embodiments, the CO₂ uptake of the MOF material is 1 to 2 times higher than that of a UiO-66-(OH)₂ material in the absence of X.

In some embodiments, the UiO-66-X MOF is in the form of octahedral-shaped particles with no agglomeration.

In some embodiments, the UiO-66 present in the UiO-66-X MOF is connected to the X via a silicate bond (—O—Si—).

In some embodiments, a method for capturing carbon dioxide directly from a CO₂-containing gaseous composition is described. The method includes contacting and passing the CO₂-containing gaseous composition through particles of the MOF material, thereby adsorbing at least a portion of CO₂ from the CO₂-containing gaseous composition onto surfaces of the MOF material particles and forming a purified gas composition.

In some embodiments, the CO₂ is present in the CO₂-containing gaseous composition in an amount of 0.01 to 5 wt. % based on a total weight of the CO₂-containing gaseous composition.

In some embodiments, the CO₂-containing gaseous composition further comprises at least one gas selected from the group consisting of hydrogen, nitrogen, oxygen, argon, helium, neon, xenon, and krypton.

In some embodiments, the CO₂-containing gaseous composition comprises CO₂ and N₂, wherein the MOF material has a Henry's Law selectivity for CO₂ over N₂ of about 160.

In some embodiments, the purified gas composition is substantially free of CO₂.

In some embodiments, a method for the preparation of the MOF material is described. The method includes mixing a UiO-66-(OH)₂ MOF, an aminosilane compound and an organic solvent to form a mixture. The method further includes heating the mixture so that the hydroxyl functional group of the UiO-66-(OH)₂ MOF reacts with alkoxysilane functional group of the aminosilane compound to form the MOF material in the mixture. The method further includes separating the MOF material from the mixture by centrifuging, washing, and drying.

In some embodiments, the aminosilane compound is at least one of (3-aminopropyl)trimethoxysilane, (3-aminopropyl)triethoxysilane, (3-aminopropyl)methyl dimethoxysilane and (3-aminopropyl)methyldiethoxysilane.

In some embodiments, a molar ratio of UiO-66-(OH)₂ MOF to aminosilane compound is in a range of 1:2 to 1:6.

In certain embodiments, the organic solvent is ethanol.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of making a metal-organic framework (MOF) material, according to certain embodiments;

FIG. 2 is a schematic representation depicting the synthesis of UiO-66-APTES (3-aminopropyl triethoxysilane), according to certain embodiments;

FIG. 3 shows Powder X-ray diffraction (PXRD) patterns of UiO-66, UiO-66-(OH)₂, and UiO-66-APTES samples, according to certain embodiments;

FIG. 4 shows a Fourier Transform Infrared Spectroscopy (FTIR) of UiO-66-(OH)₂ and UiO-66-APTES samples, according to certain embodiments;

FIG. 5A is an X-ray Photoelectron Spectroscopy (XPS) spectrogram showing deconvoluted peaks for UiO-66-(OH)₂ and UiO-66-APTES samples and showing peaks of carbon, according to certain embodiments;

FIG. 5B is an XPS spectrogram showing deconvoluted peaks for UiO-66-(OH)₂ and UiO-66-APTES samples and showing peaks of silicon, according to certain embodiments;

FIG. 5C is an XPS spectrogram showing deconvoluted peaks for both UiO-66-(OH)₂ and UiO-66-APTES samples and showing peaks of oxygen, according to certain embodiments;

FIG. 5D is an XPS spectrogram showing deconvoluted peaks for UiO-66-(OH)₂ and UiO-66-APTES samples and showing peaks of zirconium, according to certain embodiments;

FIG. 6 shows a thermogravimetric analysis (TGA) of UiO-66-(OH)₂ and UiO-66-APTES samples under the flow of air, according to certain embodiments;

FIG. 7A shows a scanning electron microscopy (SEM) micrograph of UiO-66-APTES sample at 4000× magnification, according to certain embodiments;

FIG. 7B shows an SEM micrograph of UiO-66-APTES sample at 8000× magnification, according to certain embodiments;

FIG. 7C shows an Energy dispersive X-ray (EDX) analysis of UiO-66-(OH)₂ sample, according to certain embodiments;

FIG. 7D shows an EDX analysis of UiO-66-APTES sample, according to certain embodiments;

FIG. 8A shows low-pressure N₂ isotherms measured at 77 K for UiO-66-(OH)₂ and UiO-66-APTES samples, according to certain embodiments;

FIG. 8B shows pore size distributions (PSD) for UiO-66-(OH)₂ and UiO-66-APTES samples calculated using non-local density functional theory (NLDFT) with N₂ at 77 K on carbon model, according to certain embodiments;

FIG. 9A shows CO₂ and N₂ adsorption isotherms at 273 K for UiO-66-(OH)₂ and UiO-66-APTES samples, according to certain embodiments;

FIG. 9B shows CO₂ and N₂ adsorption isotherms at 298 K for the UiO-66-(OH)₂ and UiO-66-APTES samples, according to certain embodiments;

FIG. 9C shows an initial slope selectivity figure for CO₂ and N₂ at 298K for UiO-66-(OH)₂ sample, according to certain embodiments;

FIG. 9D shows the initial slope selectivity figure for CO₂ and N₂ at 298K for UiO-66-APTES sample, according to certain embodiments;

FIG. 10 shows CO₂ adsorption/desorption multi-cycles for UiO-66-APTES sample, according to certain embodiments;

FIG. 11 shows a breakthrough curve of CO₂ from air using UiO-66-APTES as sorbent, according to certain embodiments;

FIG. 12 shows multi-cycle dynamic breakthrough experiments of CO₂ separation from air mixture, according to certain embodiments; and

FIG. 13 shows a custom-made dynamic separation breakthrough system for the multi-component gas separation experiments, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, “metal-organic frameworks” or MOFs are compounds having a lattice structure made from (i) a cluster of metal ions as vertices (“cornerstones”) (“secondary building units” or SBUs) which are metal-based inorganic groups, for example, metal oxides and/or hydroxides, linked together by (ii) organic linkers. The linkers are usually at least bidentate ligands that coordinate with the metal-based inorganic groups via functional groups such as carboxylates and/or amines. MOFs are considered coordination polymers made up of (i) metal ion clusters and (ii) linker building blocks.

As used herein, the term “room temperature” or “ambient temperature” generally refers to a temperature in a range of 25 degrees Celsius (° C.)±3° C. in the present disclosure.

As used herein, “compound” refers to a chemical entity, whether as a solid, liquid, or gas, and whether in a crude mixture or isolated and purified.

As used herein, the term “alkyl”, unless otherwise specified, refers to a straight, branched, or cyclic, saturated aliphatic fragment having 1 to 26 carbon atoms, (e.g., C1, C2, C3, C4, C5, C6, C7, C8, C9, C10, C11, etc.) and specifically includes, but is not limited to, methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, tetradecyl, pentadecyl, hexadecyl, heptadecyl, octadecyl, nonadecyl, eicosyl, guerbet-type alkyl groups (e.g., 2-methylpentyl, 2-ethylhexyl, 2-propylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl), as well as cyclic alkyl groups (cycloalkyls) such as cyclopropyl, cyclobutyl, cyclopentyl, cyclohexyl, norbornyl, and adamantyl. Throughout the specification and the appended claims, a given chemical formula or name shall encompass all isomers (stereo and optical isomers and racemates) thereof, where such isomers exist. Unless otherwise indicated, all chiral (enantiomeric and diastereomeric) and racemic forms are within the scope of the disclosure. It should be understood that all conformers, rotamers, or conformational isomer forms, as far as they may exist, are included within the present disclosure. Exemplary moieties with which the alkyl group can be substituted may be selected from the group including, but not limited to, hydroxyl, amino, alkylamino, arylamino, alkoxy, aryloxy, nitro, cyano, sulfonic acid, sulfate, phosphonic acid, phosphate, halo, or phosphonate or mixtures thereof. The substituted moiety may be either protected or unprotected as necessary, as known to those skilled in the art.

As used herein, the term “substituted” generally refers to at least one hydrogen atom replaced with a non-hydrogen group, provided that normal valences are maintained and the substitution results in a stable compound. When a substituent is noted as “optionally substituted”, the substituents are selected from the exemplary group including, but not limited to, halo, hydroxyl, alkoxy, oxo, alkanoyl, aryloxy, alkanoyloxy, amino, alkylamino, arylamino, arylalkylamino, disubstituted amines (e.g. in which the two amino substituents are selected from the exemplary group including, but not limited to, alkyl, aryl or arylalkyl), alkanylamino, aroylamino, aralkanoylamino, substituted alkanoylamino, substituted arylamino, aubstituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide (e.g. —SO₂NH₂), substituted sulfonamide, nitro, cyano, carboxy, carbamyl (e.g. —CONH₂), substituted carbamyl (e.g. —CONHalkyl, —CONHaryl, —CONHarylalkyl or cases where there are two substituents on one nitrogen from alkyl, aryl, or alkylalkyl), alkoxycarbonyl, aryl, substituted aryl, guanidine, heterocyclyl (e.g. indolyl, imidazoyl, furyl, thienyl, thiazolyl, pyrrolidyl, pyridyl, pyrimidiyl, pyrrolidinyl, piperidinyl, morpholinyl, piperazinyl, homopiperazinyl and the like), substituted heterocyclyl and mixtures thereof and the like. The substituents may be optionally substituted and may be either unprotected or protected as necessary, as known to those skilled in the art, for example, as taught.

The present disclosure is intended to include all hydration states of a given compound or formula, unless otherwise noted or when heating a material.

As used herein, the term “optionally” generally refers to includes substituted alkyl groups. The examples include, but are not limited to, hydroxy, amino, alkylamino, arylamino, alkoxy, aryloxy, nitro, cyano, sulfonic acid, sulfate, phosphonic acid, phosphate, halo, or phosphonate or mixtures thereof. The substituted moiety may be either protected or unprotected as necessary, as known to those skilled in the art.

As used herein, the term “cycloalkyl” generally refers to cyclized alkyl groups. Suitable examples of cycloalkyl groups include but are not limited to, cyclopropyl, cyclobutyl, cyclopentyl, cyclohexyl, norbornyl, and adamantly, 1-methylcyclopropyl and 2-methylcyclopropyl.

As used herein, the term “alkoxy” generally refers to a straight or branched chain alkoxy including, but not limited to, methoxy, ethoxy, propoxy, isopropoxy, butoxy, isobutoxy, secondary butoxy, tertiary butoxy, pentoxy, isopentoxy, hexyloxy, heptyloxy, octyloxy, nonyloxy, and decyloxy.

As used herein, the term “aryl” unless otherwise specified generally refers to functional groups or substituents derived from an aromatic ring including, but not limited to, phenyl, biphenyl, napthyl, thienyl, and indolyl.

As used herein, the term “halogen” generally refers to fluorine, chlorine, bromine and iodine.

Throughout the specification and the appended claims, a given chemical formula or name shall encompass all isomers (stereo and optical isomers and racemates) thereof where such isomers exist. Unless otherwise indicated, all chiral (enantiomeric and diastereomeric) and racemic forms are within the scope of the disclosure. Many geometric isomers of C═C double bonds, C═N double bonds, ring systems, and the like can also be present in the compounds, and all such stable isomers are contemplated in the present disclosure. Cis- and trans- (or E- and Z-) geometric isomers of the compounds of the present disclosure are described and may be isolated as a mixture of isomers or as separated isomeric forms. The present compounds can be isolated in optically active or racemic forms. Optically active forms may be prepared by resolution of racemic forms or by synthesis from optically active starting materials. All processes used to prepare compounds of the present disclosure and intermediates made therein are considered to be part of the present disclosure. When enantiomeric or diastereomeric products are prepared, they may be separated by conventional methods, for example, by chromatography, fractional crystallization, or through the use of a chiral agent. Depending on the process conditions the end products of the present disclosure are obtained either in free (neutral) or salt form. Both the free form and the salts of these end products are within the scope of the disclosure. If so desired, one form of a compound may be converted into another form. A free base or acid may be converted into a salt; a salt may be converted into the free compound or another salt; a mixture of isomeric compounds of the present disclosure may be separated into the individual isomers. Compounds of the present disclosure, in free form and salts thereof, may exist in multiple tautomeric forms, in which hydrogen atoms are transposed to other parts of the molecules and the chemical bonds between the atoms of the molecules are consequently rearranged. It should be understood that all tautomeric forms, insofar as they may exist, are included within the disclosure. Further, a given chemical formula or name shall encompass all conformers, rotamers, or conformational isomers thereof where such isomers exist. Different conformations can have different energies, can usually interconvert, and are very rarely isolatable. There are some molecules that can be isolated in several conformations. For example, atropisomers are isomers resulting from hindered rotation about single bonds where the steric strain barrier to rotation is high enough to allow for the isolation of the conformers. It should be understood that all conformers, rotamers, or conformational isomer forms, insofar as they may exist, are included within the present disclosure.

As used herein, “sorbent” refers to a material that can be used for the absorption of liquids or gases. These, sometimes, refer to materials that can be used for capturing another substance that is otherwise difficult to capture.

As used herein, “direct air capture” refers to strategies or technologies for capturing carbon dioxide directly from air or atmospheric air.

As used herein, “pore size” may be considered the length or longest dimensions of a pore opening. As used herein, “pore volume refers to the void volume of a porous structure and is calculated as void content per unit weight (cm³/g). As used herein, “linker” refers to entities that are used to join functional groups of compounds. These may be cleavable or non-cleavable. As used herein, “covalent bond” refers to a bond formed between atoms resulting from the formation of electron pairs due to sharing of electrons between atoms.

As used herein, “molar ratio” refers to the ratio of the amounts in moles of the compounds present in a mixture or participating in a chemical reaction.

As used herein, “RPM” stands for revolutions per minute. It refers to the speed of a centrifuge rotor and is a measure of the number of full rotations a centrifuge is making in one minute.

The present disclosure is intended to include all hydration states of a given compound or formula, unless otherwise noted or when heating a material. Unless otherwise noted, the present disclosure is intended to include all isotopes of a given compound or formula.

Aspects of the present disclosure are directed to a metal-organic framework (MOF) material containing a UiO-66 MOF for direct air capture of carbon dioxide from a mixture of gases. The UiO-66 MOF herein, e.g., preferably refer to a formula of UiO-66-APTES, which is prepared by chemical modification UiO-66-(OH)₂ framework with 3-aminopropyl triethoxysilane (APTES) to form the UiO-66-APTES framework.

A first aspect of the present disclosure is directed to a MOF material prepared by functionalization of UiO-66. The MOF material includes a compound X attached to UiO-66, wherein the MOF has a formula of UiO-66-X. In certain embodiments, X may be a silane compound. In a preferred embodiment, X is an aminosilane compound. In some further embodiments, X is an aminosilane compound with one or more primary amine groups. In some further embodiments, X is an aminosilane compound with one or more secondary amine groups. In some further embodiments, X is an aminosilane compound with one or more primary or secondary amine groups.

In some embodiments, the compound X is of the formula (I).

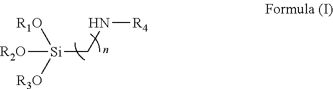

In some embodiments, R₁, R₂, and R₃ are each independently selected from the group of a hydrogen atom, an optionally substituted alkyl, an optionally substituted cycloalkyl, and an optionally substituted alkoxy. In some embodiments, R₄ is selected from the group of a hydrogen atom, an optionally substituted alkyl, an optionally substituted aryl, and a poly(alkylene amino). In some preferred embodiments, the optionally substituted alkyl includes methyl, ethyl, phenyl and methylphenyl, and ethyl phenyl. In some preferred embodiments, the optionally substituted cycloalkyl comprises 3 to 10 annular atoms (C₃-C₁₀ cycloalkyl). In some preferred embodiments, the optionally substituted alkoxy comprises methoxy, ethoxy, propoxy, isopropoxy, n-butoxy, isobutoxy, 2-butoxy, and tert-butoxy. In some embodiments, n is an integer from 1 to 20. In some preferred embodiments, n is an integer from 3 to 18, preferably 5 to 16, preferably 7 to 14, or even more preferably 9 to 12. Other ranges are also possible.

In some embodiments, a molar ratio of UiO-66 to X present in the UiO-66-X MOF is in a range of 1:1 to 1:8, preferably 1:2, preferably 1:3, preferably 1:4, preferably 1:5, preferably 1:6, or even more preferably 1:7. Other ranges are also possible.

In some embodiments, the compound X is at least one of (3-aminopropyl)trimethoxysilane, (3-aminopropyl)triethoxysilane (APTES), (3-aminopropyl)methyl dimethoxysilane and (3-aminopropyl)methyldiethoxysilane. In a preferred embodiment, the compound X is (3-aminopropyl)triethoxysilane. The compound X is grafted on the UiO-66 framework, preferably via a covalent bond. Optionally, a linker may be used as well to facilitate the covalent bonding of the compound X to the UiO-66 framework. In an embodiment, the linker may be a hydroxyl group. The UiO-66 and X are bonded via a silicate bond; the silicate bond (—O—Si—) is formed by the reaction of —OH— group from UiO-66-(OH)₂ and silane group of the aminosilane compound, to form the UiO-66-X MOF.

The MOF of the present disclosure can be used for selective direct air capture (DAC) of carbon dioxide (CO₂). The addition of the compound X to the MOF enhances the CO₂ adsorption capacity of the MOF material.

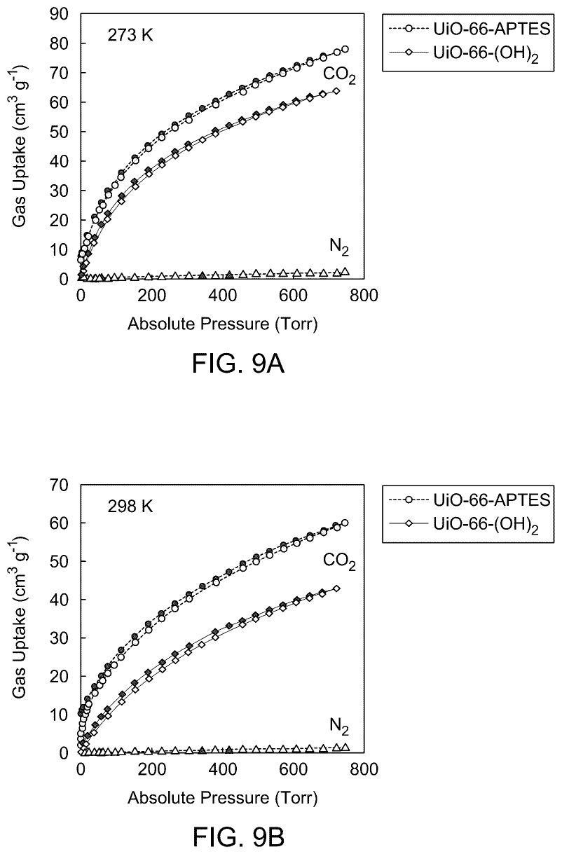

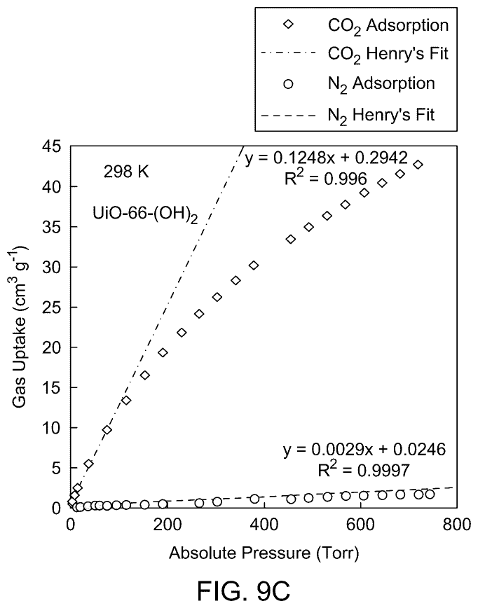

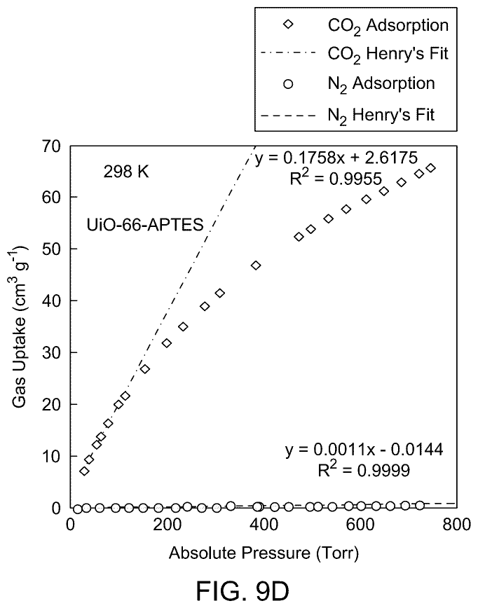

In some embodiments, the CO₂ uptake capacity for UiO-66-(OH)₂ and the MOF material were measured at a temperature of 250-330 K, preferably 270-300 K and a pressure of 0.1 to 5 bar, preferably 0.5 to 3 bar, or even more preferably about 1 bar. In an embodiment, the CO₂ uptake capacity of the MOF material is 60 to 70, preferably 62 to 68, preferably 64 to 66, or even more preferably 65 cm³/g at 270-300 K and 1 bar, as depicted in FIGS. 9A and 9B. In an embodiment, the CO₂ uptake capacity of the UiO-66-(OH)₂ is 30 to 50, preferably 34 to 48, preferably 38-46, or even more preferably about 42 cm³/g at 270-300 K and 1 bar, as depicted in FIGS. 9A and 9B. In a preferred embodiment, the CO₂ uptake capacity of the MOF material is at least 1-4 times, or even more preferably at least 1-2 times, higher than the CO₂ uptake capacity of UiO-66-(OH)₂ when X is not present. Other ranges are also possible

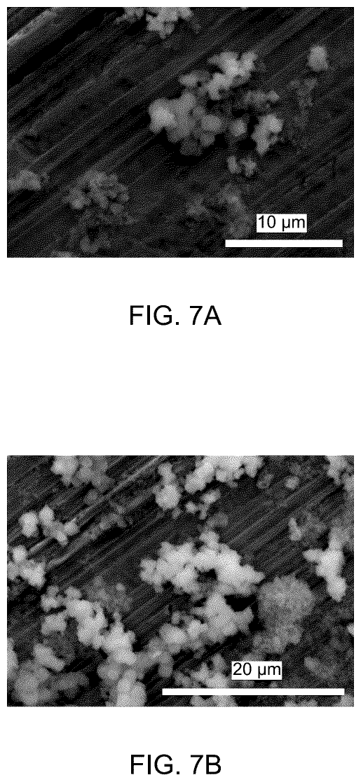

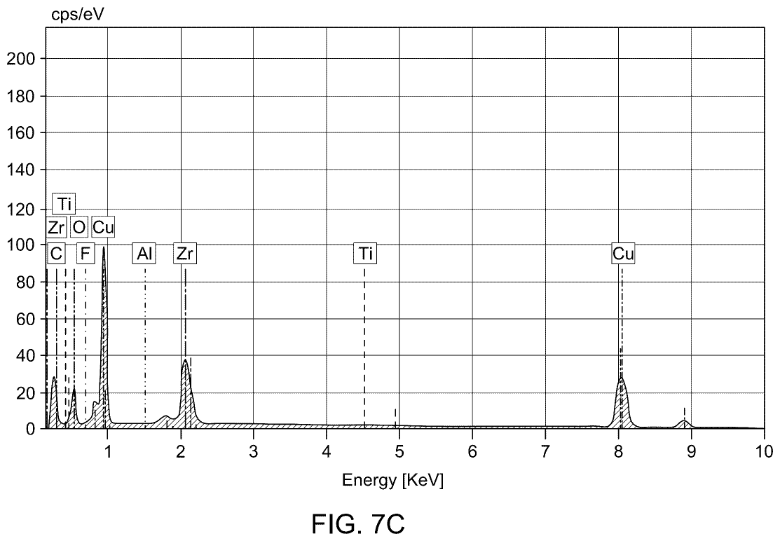

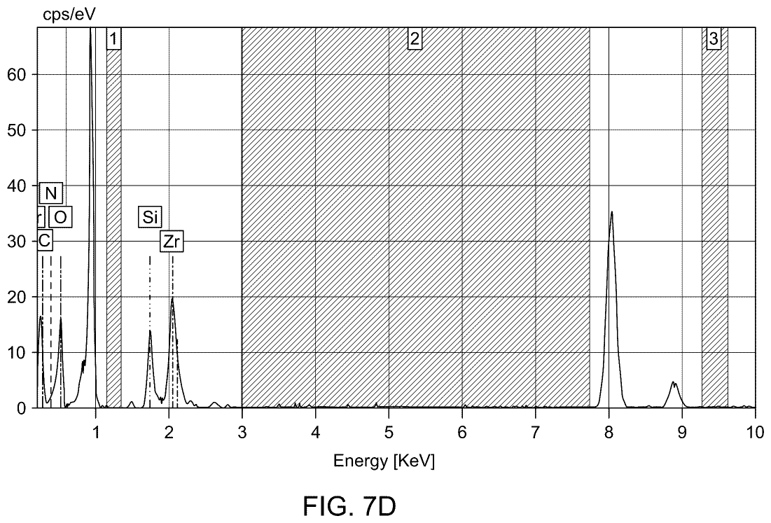

In some embodiments, the MOF material includes particles having crystal shape with no agglomeration of particles. The particles may have a similar shape as that of UiO-66-(OH)₂ or may preferably have an octahedral shape with no agglomeration of particles, as depicted in FIGS. 7A and 7B.

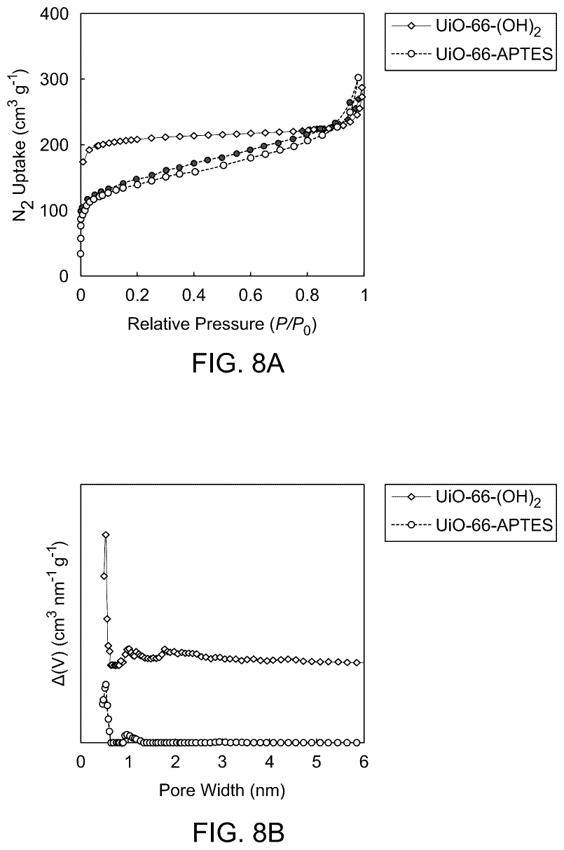

In some embodiments, the Brunauer-Emmett-Teller (BET) surface area for the MOF material of the present disclosure is in a range of 330 to 430, preferably 340 to 420, preferably 350 to 410, preferably 360 to 400, preferably 380 to 390 square meter per gram (m²/g), as depicted in FIG. 8A. BET is a technique for measuring specific surface areas of materials including MOFs. It is based on the physical adsorption of a gas on a solid surface. Nitrogen (N₂) is employed for this purpose as it does not react chemically with the adsorptive surface. The Langmuir surface area for the MOF material is in a range of 425 to 525, preferably 435 to 515, preferably 445 to 505, preferably 455 to 495, preferably 465 to 485 m²/g. Other ranges are also possible. Langmuir surface areas are calculated based on the adsorption capacity of the adsorbent and assumes that a single layer of adsorbent is adsorbed on a uniform surface.

The porosity of the MOF material is measured in terms of its pore size and pore volume. In some embodiments, the MOF material has a pore volume of 0.05 to 0.2, preferably 0.08 to 0.18, preferably 0.11 to 0.15, and yet more preferably of about 0.13 cubic centimeters per gram (cm³/g); and a pore size of 9 to 12, preferably 10-11, preferably 10.5-10.6 nanometers (nm), as depicted in FIG. 8B. Other ranges are also possible.

Another aspect of the present disclosure is directed to a method for capturing carbon dioxide directly from a CO₂-containing gaseous composition. In some embodiments, the CO₂-containing gaseous composition is a mixture of various gases, including carbon dioxide. In one embodiment, the CO₂-containing gaseous composition is a composition resembling the composition of air. Accordingly, the CO₂-containing gaseous composition may include but is not limited to, nitrogen, hydrogen, oxygen, water (vapor), carbon monoxide, hydrocarbons having 1-4 carbon atoms (e.g., methane, ethane, ethylene, acetylene, propane, propylene, butane, iso-butane), nitrogen oxides (i.e., nitric oxide, nitrous oxide, nitrogen dioxide), and noble gases (e.g., helium, neon, argon, krypton, xenon), including mixtures thereof. In some embodiments, the CO₂ may be sourced from large fossil fuel or biomass electricity power plants, industries with major CO₂ emissions, natural gas processing, synthetic fuel plants, and fossil fuel-based hydrogen production plants.

In certain embodiments, the CO₂-containing gaseous composition includes carbon dioxide in an amount of 0.01 to 5 wt. %, preferably 0.02 to 4 wt. %, preferably 0.03 to 3 wt. %, preferably 0.04 to 2 wt. %, preferably 0.05 to 1 wt. %, preferably 0.06 to 0.9 wt. %, preferably 0.07 to 0.8 wt. %, preferably 0.06 to 0.7 wt. %, preferably 0.05 to 0.6 wt. %, preferably 0.04 to 0.5 wt. %, preferably 0.06 to 0.4 wt. %, preferably 0.07 to 0.3 wt. %, preferably 0.08 to 0.2 wt. %, preferably 0.09 to 0.1 wt. % based on the total weight of the CO₂-containing gaseous composition. Other ranges are also possible.

In some other embodiments, the CO₂-containing gaseous composition includes carbon dioxide in an amount of at least 5 wt. %, preferably at least 10 wt. %, preferably at least 20 wt. %, preferably at least 30 wt. %, preferably at least 40 wt. %, preferably at least 50 wt. %, preferably at least 60 wt. %, preferably at least 70 wt. %, preferably at least 80 wt. %, preferably at least 90 wt. %, or even more preferably at least 99 wt. %, based on the total weight of the CO₂-containing gaseous composition. Other ranges are also possible.

In some further embodiments, the CO₂-containing gaseous composition includes carbon dioxide in an amount of 0.01 to 10 vol. %, preferably 0.02 to 8 vol. %, preferably 0.03 to 6 vol. %, preferably 0.04 to 4 vol. %, preferably 0.05 to 2 vol. %, preferably 0.06 to 1 vol. %, preferably 0.07 to 0.8 vol. %, preferably 0.06 to 0.7 vol. %, preferably 0.05 to 0.6 vol. %, preferably 0.04 to 0.5 vol. %, preferably 0.06 to 0.4 vol. %, preferably 0.07 to 0.3 vol. %, preferably 0.08 to 0.2 vol. %, preferably 0.09 to 0.1 vol. % based on a total volume of the CO₂-containing gaseous composition.

Other ranges are also possible.

In some other embodiments, the CO₂-containing gaseous composition includes carbon dioxide in an amount of at least 5 vol. %, preferably at least 10 vol. %, preferably at least 20 vol. %, preferably at least 30 vol. %, preferably at least 40 vol. %, preferably at least 50 vol. %, preferably at least 60 vol. %, preferably at least 70 vol. %, preferably at least 80 vol. %, preferably at least 90 vol. %, or even more preferably at least 99 vol. %, based on the total volume of the CO₂-containing gaseous composition. Other ranges are also possible.

The CO₂-containing gaseous composition is contacted and passed through the particles of the MOF material. In some embodiments, the MOF material may be supported on a surface of a solid support. The surface may be in the form of a bed and may have any shape, including square, cylindrical, tubular, or rectangular. In some further embodiments, one or more adsorbents may be supported on the surface of the solid support in the presence of the MOF material. The one or more adsorbents and the MOF material may thereof exhibit a synergistic effect on CO₂ uptake compared to the one or more adsorbents if used alone. In some embodiments, the one or more adsorbents may comprise, but are not limited to, activated carbon adsorbent, amine impregnated adsorbent supports (comprising silica, activated carbon, alumina, zeolite, polymer and ceramic supports), metal salt, metal hydroxide, metal oxide, zeolite, hydrotalcite, silicalite, metal organic framework and zeolitic imadazolate framework adsorbent materials, and combinations thereof.

Upon contact, at least a portion of CO₂ from the CO₂-containing gaseous composition is adsorbed onto surfaces of the MOF material particles, thereby forming a purified gas composition. The purified gas composition is substantially free of CO₂. The phrase “substantially free”, suggests that the CO₂ is present in an amount of less than about 1 wt. %, preferably less than about 0.5 wt. %, more preferably less than about 0.1 wt. %, even more preferably less than about 0.05 wt. %, yet even more preferably 0 wt. %, relative to the CO₂-containing gaseous composition. Other ranges are also possible.

The MOF material shows a higher selectivity for CO₂ over other gases, including N₂. In one embodiment, where the gaseous composition includes CO₂ and N₂, the MOF material displays a Henry's law selectivity for CO₂ over N₂. In some embodiments, where the gaseous composition comprises CO₂ and N₂, the MOF material displays a Henry's law selectivity of about 140 to 170, preferably 150 to 160, preferably 160 for CO₂ over N₂, as depicted in FIGS. 9C and 9D. In some embodiments, a flow rate ratio of CO₂ and N₂ present in the gaseous composition is in a range of 20:1 to 1:20, preferably 15:1 to 1:15, preferably 10:1 to 1:10, preferably 5:1 to 1:5, or even more preferably about 1:1. Other ranges are also possible.

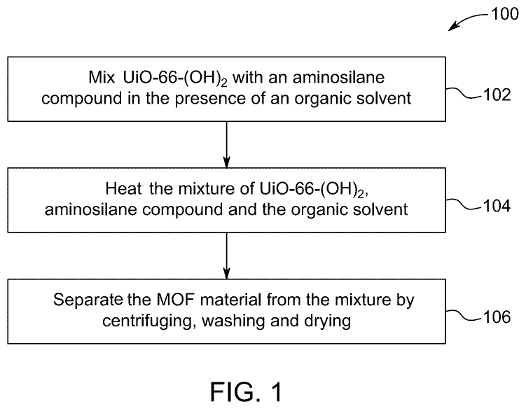

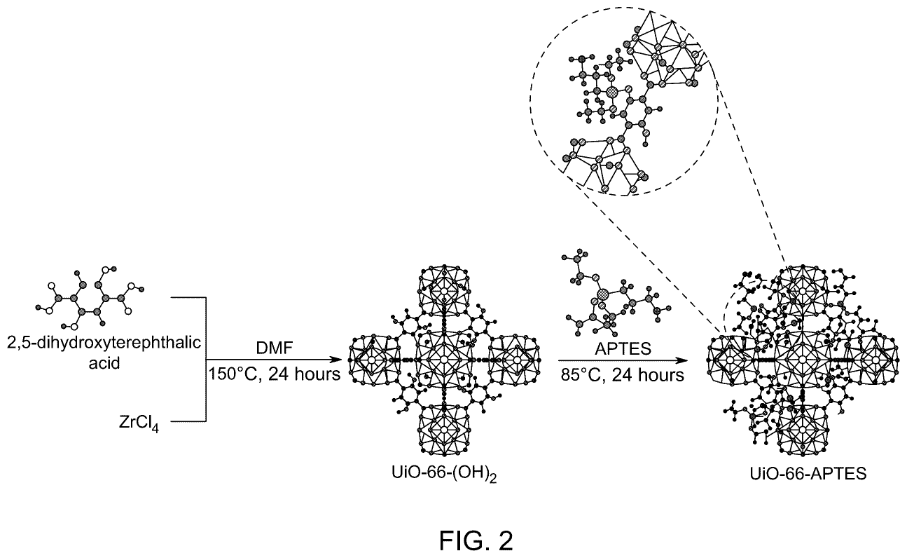

FIG. 1 illustrates method 100 for the preparation of the MOF material. The MOF material is prepared by covalently attaching a compound X to UiO-66-(OH)₂, and the chemical structure and functionalization of UiO-66 can be understood with reference to the FIG. 2. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes mixing UiO-66-(OH)₂ with an aminosilane compound in the presence of an organic solvent. In some embodiments, the aminosilane is a silane compound wherein one or more hydrogen atoms are replaced by one or more amino groups. In some embodiments, the aminosilane compound is at least one selected from a group consisting of (3-aminopropyl) trimethoxysilane, (3-aminopropyl)triethoxysilane, (3-aminopropyl)methyl dimethoxysilane and (3-aminopropyl) methyldiethoxysilane. In some embodiments, the aminosilane compound is (3-aminopropyl) trimethoxysilane. In some embodiments, the aminosilane compound is (3-aminopropyl) triethoxysilane. UiO-66-(OH)₂ and aminosilane compound are mixed in a solvent. In one embodiment, the solvent is an organic solvent. Suitable examples of the organic solvent include tetrahydrofuran, ethyl acetate, dimethylformamide (DMF), acetonitrile, acetone, dimethyl sulfoxide, nitromethane, propylene carbonate, ethanol, formic acid, n-butanol, methanol, benzene, cyclohexane, ethyl acetate, dichloromethane, toluene, and diethyl ether, or any combination thereof. In a preferred embodiment, the organic solvent is ethanol. In one embodiment, the UiO-66-(OH)₂ is mixed with the aminosilane compound (compound X) in a molar ratio of 1:1 to 1:8, preferably 1:2, preferably 1:3, preferably 1:4, preferably 1:5, preferably 1:6, preferably 1:7 for the synthesis of UiO-66-X MOF. Other ranges are also possible.

At step 104, the method 100 includes heating the mixture of UiO-66-(OH)₂, aminosilane compound, and the organic solvent. In some embodiments, the mixture is heated at a temperature of 60° C. to 100° C., preferably at a temperature of 70° C. to 90° C., preferably 80° C. In some embodiments, the mixture is heated for a period of 20-30 h, preferably for a period of 22-28 h, preferably for a period of 24-26 h, preferably for a period of 24 h to obtain the MOF material. Other ranges are also possible.

At step 106, the method 100 includes separating the MOF material from the mixture by centrifuging. The centrifugation may be carried out at 10,000-15,000 RPM, preferably 12,000-14,000 RPM, preferably 12,000 RPM. The centrifugation of the MOF material for 2-10 minutes, preferably 3-9 minutes, preferably 4-8 minutes, preferably 5 minutes, is sufficient for the separation of MOF material from the mixture. Other ranges are also possible. In some embodiments, the MOF material may be washed one or more times, preferably with the organic solvent, to remove any unreacted material. In some embodiments, the MOF material may be washed twice with an organic solvent. In specific embodiments, the MOF material may be washed twice with ethanol. After washing, the MOF material may be dried for 60-100° C., preferably 70-90° C., preferably 80° C., to form the purified MOF material. The drying is done for a period of 10-12 hours. Other ranges are also possible. In a preferred embodiment, the drying is carried out overnight to obtain a sufficiently dry and purified MOF material. The drying can be done by using heating appliances such as ovens, microwaves, autoclaves, hot plates, heating mantles and tapes, oil baths, salt baths, sand baths, air baths, hot-tube furnaces, and hot-air guns.

The method 100 may further includes a step of preparing the UiO-66-(OH)₂. In some embodiments, the UiO-66-(OH)₂ of the present disclosure include zirconium ion clusters (cornerstones) which are zirconium inorganic groups, typically zirconium ions connected by bridging oxygen groups, bridging hydroxide groups, or both. These zirconium ion clusters are further coordinated to at least one linker. In some cases, the zirconium ion clusters may be further connected to non-bridging modulator species, complexing reagents or ligands (e.g., sulfates or carboxylates such as formate, benzoate, acetate, etc.) and/or solvent molecules (e.g., H2O). The idealized zirconium ion cluster is considered to be a hexanuclear zirconium ion cluster based on an octahedron of zirconium ions (Zr⁴⁺) which are μ3-bridged by O₂- and/or OH-ions via the faces of the octahedron and further saturated by coordinating ligands containing oxygen atoms like carboxylate groups. Preferably, each zirconium ion cluster is coordinated by between 6 and 12 carboxylate groups, or between 8 and 11 carboxylate groups, or 10 carboxylate groups (preferentially as close as possible to 12 carboxylate groups), the carboxylate groups being from the linker and/or a modulator. However, in practice, there is a degree of flexibility in the structure of the zirconium ion cluster.

In some embodiments, the method of preparing the UiO-66-(OH)₂ includes mixing a zirconium salt, an aromatic acid, a formic acid, and a polar solvent to form a mixture. The mixture was sonicated and heated at a temperature of about 100 to 200° C., preferably 120 to 180° C., preferably 140 to 160° C., or even more preferably about 150° C. to form the UiO-66-(OH)₂ in the form of a precipitate in the mixture and recover said precipitate. In some embodiments, the zirconium salt comprises zirconium nitrate, zirconium chloride, zirconium hydroxide, zirconium sulfate, or combinations thereof. In a preferred embodiment, the zirconium salt is zirconium chloride. In some embodiments, the aromatic acid includes one or more selected from terephthalic acid, 2-aminoterephthalic acid, 2-methyl terephthalic acid, 2-nitroterephthalic acid, 2-bromoterephthalic acid, 2-hydroxy terephthalic acid, 2-sulfoterephthalic acid, 2, 5-dihydroxy-terephthalic acid or 1,3, 5-benzenetricarboxylic acid. In a preferred embodiment, the aromatic acid is 2, 5-dihydroxyterephthalic acid. In some embodiment, a molar ratio of the zirconium salt to the aromatic acid is in a range of 1:1 to 1:20, preferably 1:4 to 1:16, preferably 1:8 to 1:12, or even more preferably about 1:10. Other ranges are also possible. In some embodiments, the polar solvent is at least one selected from the group consisting of ethyl acetate, acetone, acetonitrile, dimethylformamide (DMF), dimelthylsulfoxide (DMSO), isopropanol, and methanol. In a preferred embodiment, the polar solvent is DMF.

The described framework was further tested for its capability of CO₂ separation within a gas mixture, e.g., preferably a CO₂/N₂ gas mixture. The framework showed an improved Henry's Law selectivity for CO₂ over N₂ of about 160, and a mere marginal reduction in performance (i.e., CO₂ uptake capacity) after 15 cycles, showing that the UiO-66-APTES is a suitable adsorbent for direct air capture.

### EXAMPLES

The following examples demonstrate the synthesis of a metal-organic framework (MOF) as described herein. The examples are provided solely for illustration and are not to be construed as limitations of the present disclosure, as many variations thereof are possible without departing from the spirit and scope of the present disclosure.

### Example 1: Materials and Reagents

N,N-dimethylformamide (DMF, 99.8%), zirconium (IV) chloride (ZrCl₄, 98%), methanol (MeOH, 99.9%), ethanol (EtOH, 99.9%), and acetic acid (CH₃COOH, 99.7%) were obtained from Sigma Aldrich. (3-aminopropyl) triethoxysilane (APTES, 99%) and 2,5-dihydroxyterephthalic acid (DHTA, 99%) were purchased from Alfa-Aesar. Deionized water was produced by the Milipak Express 40 Millipore device. For gas sorption measurements, ultrahigh purity grade nitrogen (99.99%), helium (99.99%), and high purity CO₂ (99.99%) have been obtained from Linde, Dammam, Saudi Arabia. The air mixture was supplied by air-liquid consisting of 20% 02, 0.05% CO₂ (500 ppm), and 79.95% N₂, which was used for direct air capture simulations through the dynamic breakthrough.

### Example 2: Instruments

All the MOF samples were characterized using a combination of techniques, including powder X-ray diffraction (PXRD), X-ray photoelectron spectroscopy (XPS), scanning electron microscopy (SEM), Fourier transform infrared spectroscopy (FTIR), thermogravimetric analysis (TGA), and N₂ adsorption/desorption isotherms. FTIR spectra were produced using potassium bromide (KBr) pellets on a PerkinElmer 16 PC spectrometer. The spectra were obtained between wavenumbers of 4000 and 500 cm¹.

The XPS analyses was performed on a Kratos AMICUS/ESCA 3400 photoelectron spectrometer from Kratos Analytical Ltd, Manchester, United Kingdom. The spectrometer is equipped with an achromatic X-ray source with a dual Al/Mg anode and an electron energy analyzer as a detector. Samples were introduced on a 0.6 cm×0.6 cm sample holder in powder form. Peaks' deconvolution was accomplished using CasaXPS software. The background is calculated with the Shirley equation, and the line shape of deconvoluted peaks is based on Gaussian/Lorentzian form.

SEM images were acquired with a field emission scanning electron microscope (FE-SEM) on a Quattro Dual Beam microscope (manufactured by thermos Fischer Scientific, United States) at a 10 kV acceleration voltage. The instrument's EDX analysis was used to determine the elemental composition, carbon, and nitrogen, of the material. The thermal stability of the materials was evaluated using the TA Q500 TGA analyzer under continuous air flow with a heating rate of 10° C. per minute. PXRD analysis was done using a Rigaku MiniFlex II instrument (manufactured by Rigaku, Japan) with Cu Ka radiation (λ=1.541 Å) in the range of 5-40 degrees and with a rate of 2 degrees/min. Porosity and low-pressure gas uptake measurements were conducted using Quantachrome Quadrasorp Evo. Volumetric analyzer (manufactured by Antor parr, Austria). The samples were activated by heating at 120° C. under reduced pressure (<50 mtorr) before the measurement. Liquid nitrogen was used for the N₂ isotherms at 77 K, measured for the Brunauer, Emmett, and Teller (BET) surface area calculation, while water chiller circulation was used for the gas uptake at 273 and 298 K isotherms. For the CO₂ adsorption/desorption multi-cycle test, a vacuum vapor sorption (DVS) analyzer was used with a pure CO₂ cylinder.

### Example 3: Synthesis of UiO-66-(OH)₂

The synthesis of the pristine UiO-66-(OH)₂ samples were done according to the described method below (See: T. M. Tovar, L Iordanov, D. F. Sava Gallis, J. B. De-Coste, Transistor-Based Work-Function Measurement of Metal-Organic Frameworks for Ultra-Low-Power, Rationally Designed Chemical Sensors, Chemistry-A European Journal 24 (2018) 1931-1937, which is incorporated herein by reference in its entirety). For example, in a 20 mL vial, about 298.0 mg of ZrCl₄ (1.28 mmol) and 285.3 mg of 2,5-dihydroxylterephthalic acid (BDC-(OH)₂), about 1.44 mmol, were dissolved separately in DMF (6 mL each) and sonicated thoroughly until fully dissolved. The solutions were mixed in a 20 mL flask before adding formic acid (4 mL) and sonicate again. The final solution was then transferred into a 40 mL Teflon-lined autoclave placed in an isothermal oven set at 150° C. and held for 24 hours. Once extracted and filtered, the yellow crystalline powder was submerged in DMF (30 mL, replaced 2 times a day for 3 days). Finally, the powder was washed with MeOH (30 mL, replaced 2 times a day for 3 days) and left to dry at 80° C. overnight.

### Example 4: Synthesis of UiO-66-APTES

In a 50 mL round bottom flask, about 500.0 mg of UiO-66-(OH)₂ were suspended in 30 ml ethanol with 3 mL of APTES. The mixture was stirred at 80° C. in an oil bath for 24 hours. The material was collected by centrifugation at 12,000 RPM for 5 min, washed two times with ethanol, and left to dry at 80° C. overnight, yielding about 718.6 mg of the final functionalized product. The chemical structure and functionalization of UiO-66-APTES are shown in FIG. 2.

### Example 5: Characterization

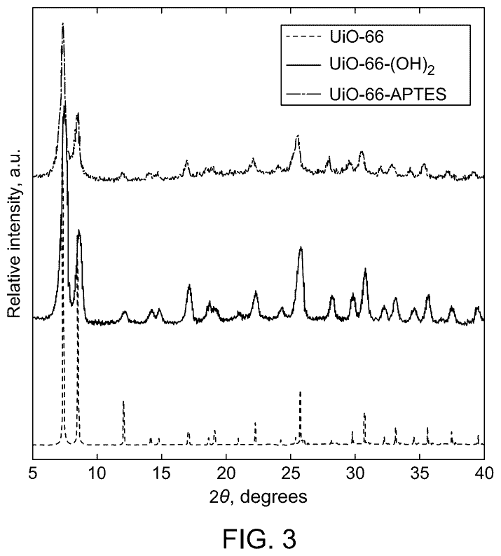

The covalent grafting of aliphatic amines on the UiO-66 framework was obtained by using its hydroxyl analog, UiO-66-(OH)₂, which enables the binding of the Si atoms of the APTES with the OH group of the linker. PXRD patterns were collected for all the synthesized MOF samples to preserve the materials' structure and crystallinity before and after the modification (FIG. 3). The collected patterns were compared with the simulated pattern of UiO-66 within the range of 5-40 degrees. Both patterns demonstrated diffraction peaks matching the Bragg diffractions of the simulated pattern of UiO-66, which shows that the UiO-66-(OH)₂ crystalline structure was maintained following the APTES loading.

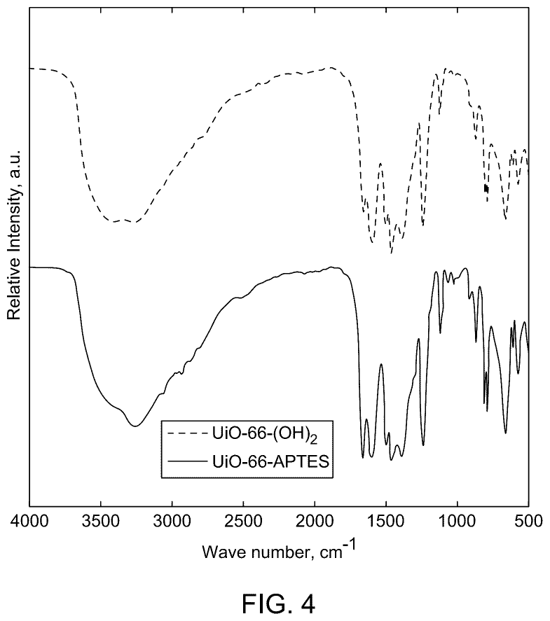

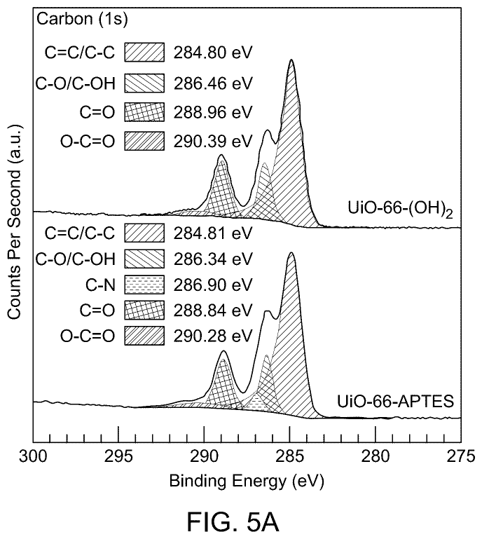

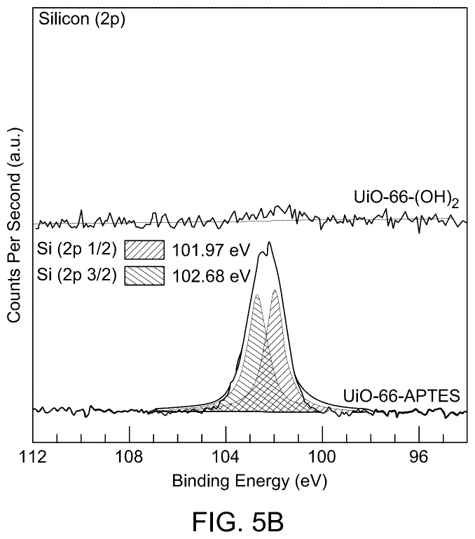

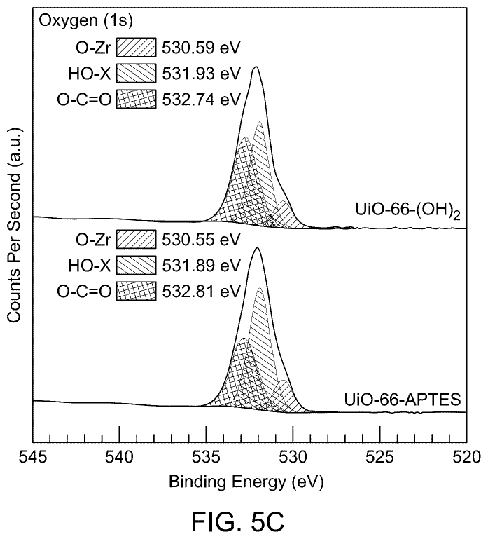

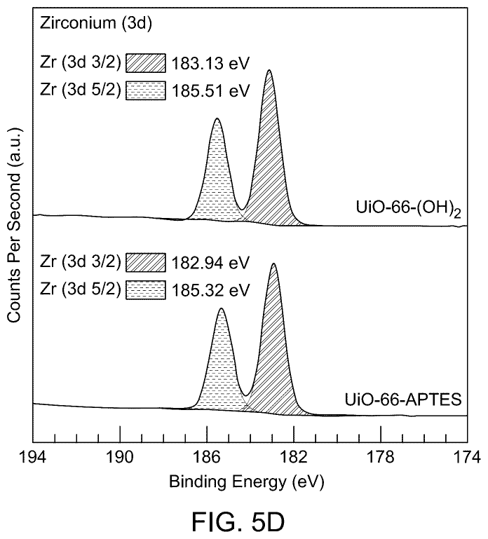

FTIR spectroscopy was used to examine the presence of APTES in the structure of UiO-66-APTES and to show the interactions between the parent material and the associated amine to ensure integration and functionalization. The spectrum shows the absorption band near 1655 cm⁻¹, which corresponds to the vibration of the C═C portion of the benzene ring (FIG. 4). Additionally, the terminal NH₂ of the APTES manifests itself in the absorption band located on 3292 cm⁻¹. Furthermore, peaks of C—H, characteristic of APTES-functionalization, are found at 2923 cm⁻¹. In addition to the band at 1114 cm⁻¹ for the Si—O—C stretching vibration [See: D. Lin-Vien, N. B. Colthup, W. G. Fateley, J. G. Grassel-li, The Handbook of Infrared and Raman Characteristic Frequencies of Organic Molecules, Elsevier, 1991, which is incorporated herein by reference in its entirety]. These results show the grafting of APTES into UiO-66-(OH)₂. XPS analysis was performed to examine the elemental composition of the material, along with the environment surrounding each element. As depicted in FIG. 5, an elemental analysis of specific constituents, including but not limited to carbon, silicon, oxygen, and zirconium, has been undertaken to verify the post-synthetic modification performed on UiO-66-(OH)₂. The carbon peak (C—C/C═C) is normalized to 284.8 eV, and the binding energies of the other elements are normalized accordingly. The examination/deconvolution of carbon peaks for both UiO-66-(OH)₂ and UiO-66-APTES, as illustrated in FIG. 5A shows an extra peak at 286.90 eV in UiO-66-APTES, corresponding to a carbon attached to an amino group (C—N). Also, silicon was observed in the UiO-66-APTES spectrum, confirming the incorporation of APTES since it is the fragment containing silicon in the framework (FIG. 5B). Furthermore, it refutes the possibility of any unwanted silicon dioxide nanoparticle inside the framework as the (Si—O—Si) peak usually appears at around 104 eV [See: A. Kaur, P. Chahal, T. Hogan, Selective fabrication of SiC/Si diodes by excimer laser under ambient conditions, IEEE Electron Device Letters. 37 (2016) 142-145, which is incorporated herein by reference in its entirety]. Oxygen peaks showed a high resemblance in the overall shape of the peaks between the modified and unmodified frameworks, with a relatively higher percentage of the hydroxy species (X—OH, 531.89 eV) in UiO-66-APTES which can be attributed to the hydrolysis of some ethoxy branches attached to the silicon atom within APTES (FIG. 5C). Finally, in FIG. 5D, the zirconium peaks of both UiO-66-(OH)₂ and UiO-66-APTES appear to be almost identical, indicating that the APTES was exclusively binding to the hydroxy groups of the framework linker, thereby leaving the zirconium secondary building unit unaffected by the modification.

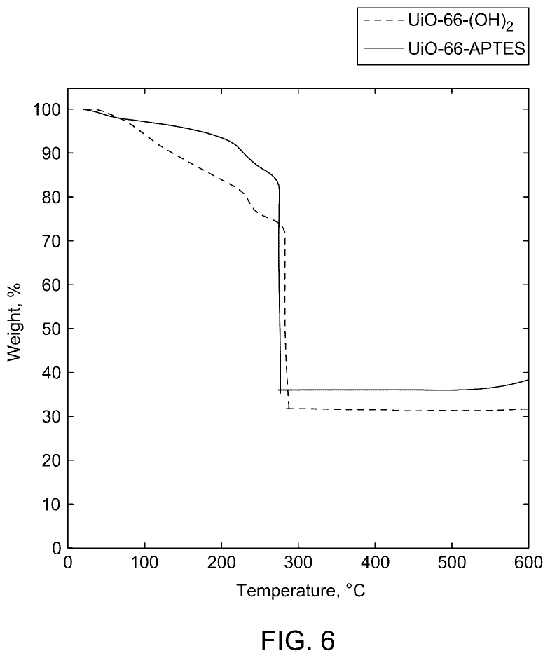

TGA was performed to examine the thermal stability of UiO-66-(OH)₂, which shows the bond strength of the newly formed bond during the post-synthetic modification. The TGA curves of UiO-66-(OH)₂ and UiO-66-APTES (FIG. 6) show a consistent overall decomposition behavior, with a steep step representing the complete collapse and decomposition of the MOFs at approximately 280° C. Three steps in weight loss were detected in both samples. The first step results from the evaporation of water and other trapped guest molecules within the pores, causing the gradual weight loss below approximately 200° C. The lack of any additional decomposition steps in UiO-66-APTES and having the same thermal stability at approximately 280° C., indicating the formation of a strong covalent bond between the silicon from APTES and the oxygen from the linker and not just any physical interaction that would have been broken at lower temperature. The residual mass detected after the complete decomposition step, in the range approximately 300-500° C., is higher in the case of UiO-66-APTES compared to UiO-66-(OH)₂. This is attributed to the additional accumulation of silicon oxide along with the zirconium oxide in the residue of UiO-66-APTES. This result confirms the post-synthetic modification.

UiO-66-APTES shows the same crystal shape as the UiO-66-(OH)₂, as confirmed by the SEM images (FIGS. 7A and 7B), and no particle aggregation has been observed. The EDX analysis was used to provide direct proof for the functionalization of UiO-66-(OH)₂ with the APTES (FIGS. 7C and 7D). A silicon peak appears at approximately 1.8 keV in the case of UiO-66-APTES which is absent in UiO-66-(OH)₂. This peak, along with another small peak at approximately 0.4 keV, which is characteristic of nitrogen, confirm the incorporation of APTES within the framework. N₂ isotherms at 77 K were performed for UiO-66-(OH)₂ and its functionalized analog UiO-66-APTES (FIG. 8A) to determine their respective surface area and pore volume (FIG. 8B). Both UiO-66-(OH)₂ and UiO-66-APTES mainly exhibit a microporous nature. BET surface areas were calculated using experimental datapoints within 0.01-0.3 P/P₀ values, and the calculated BET areas were found to be approximately 752 m² g⁻¹, and approximately 381 m² g⁻¹, for UiO-66-(OH)₂, and UiO-66-APTES respectively. The decrease in surface area is generally expected with any modification to a MOF due to the filling of the pores with the added linker functionalization that results in an overall decrease in the pore volume, as shown in Table 1.

TABLE 1
Surface areas (SA) and pore parameters
of the synthesized UiO-66 analogs.

| | | | | Avg. |
|---|---|---|---|---|
| | BET SA | Langmuir SA | Pore vol. | Pore Size |
| Samples | (m² · g⁻¹) | (m² · g⁻¹) | (cm³ g⁻¹)^{a} | (nm) |
| UiO-66-(OH)₂ | 752 | 927 | 0.56 | 10.2 |
| UiO-66-APTES | 381 | 475 | 0.13 | 10.6 |

^{a}DFT accumulated pore volume

### Example 6: CO₂ Gas Sorption Measurements

The thermodynamic CO₂ uptakes for UiO-66-(OH)₂ and UiO-66-APTES were measured at 273 K and 298 K (FIG. 9A and FIG. 9B). UiO-66-APTES showed a higher CO₂ uptake capacity compared to the unmodified UiO-66-(OH)₂, exhibiting a capacity, at 298 K and 1 bar, of 65.6 cm³ g⁻¹ and 42.7 cm³ g⁻¹ respectively. Such a change represents an approximately 150% enhancement in uptake capacity over the original UiO-66-(OH)₂ sample. The CO₂ isotherm at low pressure shows a steeper uptake, which reflects a high affinity toward CO₂.

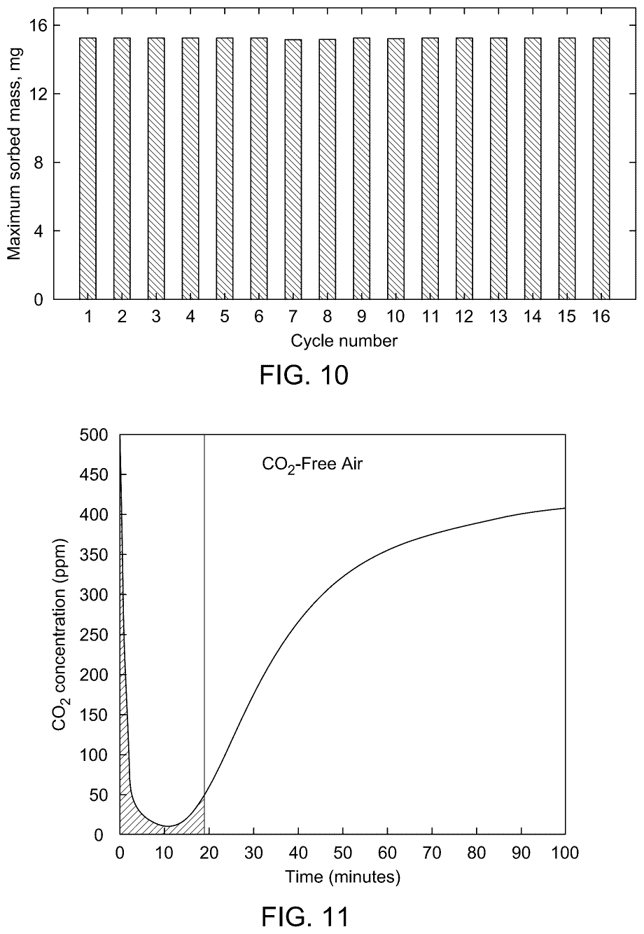

The CO₂ capture ability of the material, particularly its CO₂ selectivity for a gas mixture containing CO₂ and N₂, was measured. Therefore, the adsorption isotherms for N₂ were measured for UiO-66-(OH)₂ and UiO-66-APTES. The CO₂/N₂ selectivity was calculated from the single component isotherms of both CO₂ and N₂ at 298K. FIG. 9C and FIG. 9D show the initial slope of each isotherm at 298 K and 0-1 bar for UiO-66-(OH)₂ and UiO-66-APTES. Henry's initial slope selectivity calculations of CO₂/N₂ confirm the higher selectivity of the modified framework for CO₂ as it was found to be 160, while UiO-66-(OH)₂ is only 43. Additionally, the CO₂ adsorption/desorption multi-cycles have been performed for UiO-66-APTES (FIG. 10) using pure CO₂ adsorption on a dynamic vapor sorption device (DVS). The material showed improved stability over 15 cycles with activation between the cycles at 100° C. under vacuum.

The CO₂ adsorption uptake of UiO-66-APTES at low pressure was due to the dynamic separation of the CO₂ from diluted concentration, such as the case of CO₂ from the air. Therefore, the CO₂ uptake at a pressure of 0.04% is critical [See: H. Seo, T. A. Hatton, Electrochemical direct air capture of CO₂ using neutral red as redox-active material, Nat Commun 14 (2023) 313, which is incorporated herein by reference in its entirety].

As previously mentioned, one of the main challenges for practical CO₂ adsorbents is their slow adsorption kinetics. Therefore, it is crucial to measure the CO₂ kinetics and loading times of the UiO-66-APTES samples. As such, a temperature vacuum swing adsorption device was used to mimic the movement of actual air into the solid sorbent bed that aims to capture CO₂ from the air (FIG. 11). Dynamic breakthrough experiments were used to evaluate the effectiveness and selectivity of UiO-66-APTES in capturing CO₂ under actual ambient air conditions. In one embodiment, an activated sample of UiO-66-APTES is loaded into a bed and exposed to a flow of a gas mixture containing, e.g., preferably about 0.05% CO₂ and preferably about 21% O₂ and balance with N₂. These are volumetric percentages that are intended to resemble the composition of air. By analyzing the composition ratio of the downstream gas to the feed gas, the full breakthrough capacity of CO₂ was calculated [See: M. M. Abdelnaby, M. Aliyu, M. A. Nemitallah, A. M. Alloush, E.-H. M. Mahmoud, K. M. Ossoss, M. Zeama, M. Dowaidar, Design and Synthesis of N-Doped Porous Carbons for the Selective Carbon Dioxide Capture under Humid Flue Gas Conditions, Polymers 15 (2023) 2475, which is incorporated herein by reference in its entirety].

$${q}_{{CO}_{2}} = \frac{1}{m} FCt ( \frac{298}{273} )$$

where q_{CO}_{₂} is the CO₂ capacity (cm³ g⁻¹) at 298 K, m is the initial mass of the adsorbent (g), F is the input flow rate at STP (cm³ min⁻¹), C is the CO₂ feed concentration (vol. %), and t is the breakthrough time (minutes).

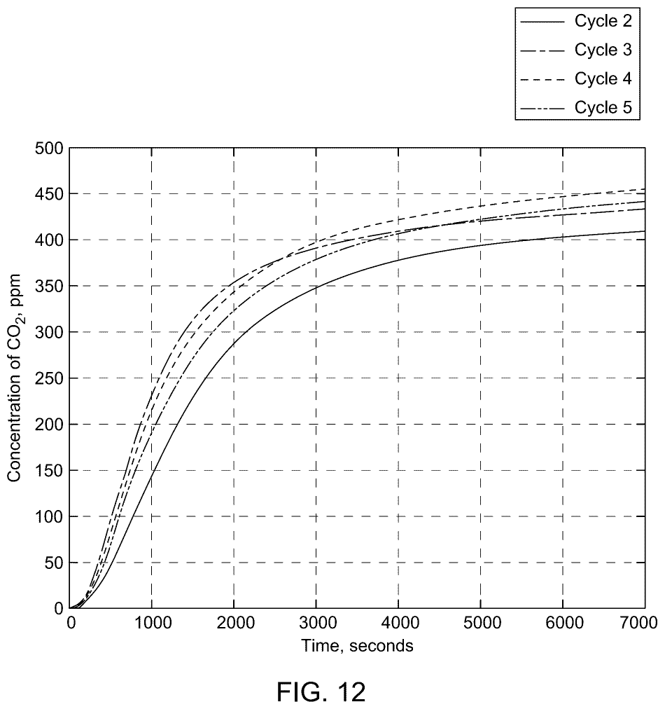

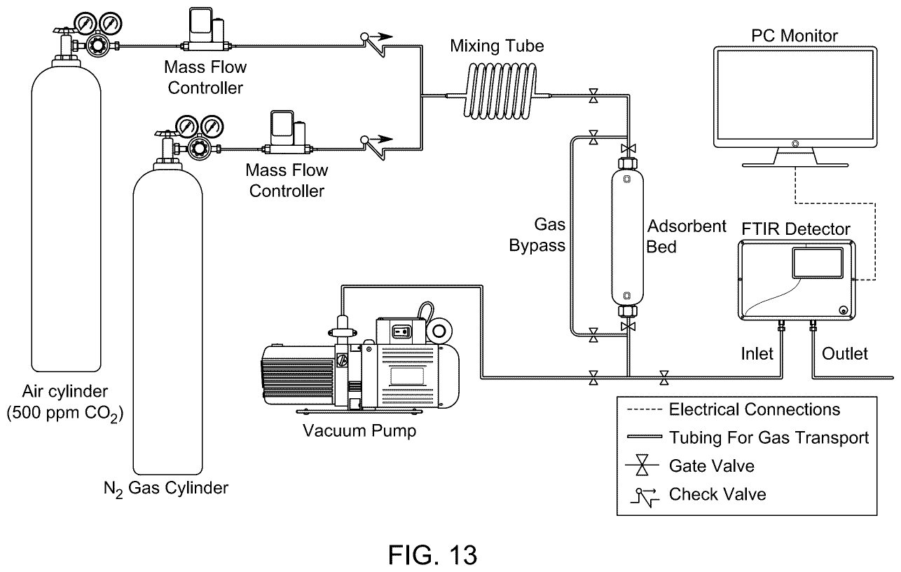

The breakthrough time (i.e., the time when a material reaches saturation and additional CO₂ molecules “breakthrough” the bed), was recorded using an online FTIR based detector. The online FTIR based detector was used to monitor the effluent composition of the CO₂ coming out of the bed throughout the test. The mean loading time for UiO-66-APTES to adsorb carbon dioxide was 19 minutes with a standard deviation of 1.4 minutes based on 5 cycles for a 0.35 g sample when the volumetric air flow rate was 20 mL per minute. The breakthrough time was considered to end with 50 ppm effluent CO₂ concentration. Based on the breakthrough time, the corresponding dynamic CO₂ uptake capacity of UiO-66-APTES was approximately about 0.60 cm³ g⁻¹. The material showed an improved stability for up to 5 dynamic breakthrough cycles FIG. 12. These results confirms UiO-66-APTES may be used as a direct air capture sorbent. FIG. 13 depicts a custom-made dynamic separation breakthrough system for the multi-component gas separation experiments.

The present disclosure provides a method for direct air capture by covalently grafting of aliphatic amines, e.g., preferably using APTES onto the hydroxy analogue of UiO-66. The CO₂ adsorption capacities of UiO-66-APTES were tested, showing an enhancement from about 42.7 cm³g⁻¹ to about 65.6 cm³g⁻¹ at 298 K and 1 bar compared to a pristine sample in the absence of the APTES. Furthermore, it exhibited a high CO₂/N₂ selectivity of 160. In one embodiment, UiO-66-APTES was tested in the aspects of CO₂ absorption, CO₂/N₂ selectivity, and stability in the application for the direct air capture. The dynamic CO₂ adsorption tests further confirmed its dynamic CO₂ uptake capacity of 0.60 cm³g⁻¹. The results indicate that the MOFs of the present disclosure can mitigate the impact of greenhouse gas emissions on our environment. The synthesis, characterization, and CO₂ adsorption test of the UiO-66-APTES may address the global challenges of CO₂ removal.

Numerous modifications and variations of the present disclosure are possible in light of the above teachings. It is therefore to be understood that within the scope of the appended claims, the invention may be practiced otherwise than as specifically described herein.

1: A metal-organic framework (MOF) material for selective direct air capture (DAC) of carbon dioxide (CO₂), comprising:
a UiO-66-X MOF;
wherein X is an aminosilane with one or more primary or secondary amine groups; and
wherein a molar ratio of UiO-66 to X present in the UiO-66-X MOF is in a range of 1:1 to 1:8.

2: The MOF material of claim 1, wherein X is of formula (I): 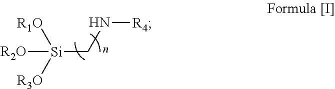
wherein R₁, R₂, and R₃ are each independently selected from the group consisting of a hydrogen atom, an optionally substituted alkyl, an optionally substituted cycloalkyl, and an optionally substituted alkoxy;
wherein R₄ is selected from the group consisting of a hydrogen atom, an optionally substituted alkyl, an optionally substituted aryl, and a poly(alkylene amino); and
n is an integer from 1 to 20.

3: The MOF material of claim 1, wherein X is (3-aminopropyl)triethoxysilane (APTES).

4: The MOF material of claim 1, having a BET surface area in a range of 330 to 430 square meter per gram (m²/g).

5: The MOF material of claim 1, having a Langmuir surface area in a range of 425 to 525 m²/g.

6: The MOF material of claim 1, having an average pore size in a range of 9 to 12 nanometers (nm).

7: The MOF material of claim 1, having an average pore volume in a range of 0.05 to 0.2 cubic centimeters per gram (cm³/g).

8: The MOF material of claim 1, having a CO₂ uptake of 60 to 70 cm³/g at 270-300 K and 1 bar.

9: The MOF material of claim 1, wherein the CO₂ uptake of the MOF material is 1 to 2 times higher than that of a UiO-66-(OH)₂ material in the absence of X.

10: The MOF material of claim 1, wherein the UiO-66-X MOF is in the form of octahedral shape particles with no agglomeration.

11: The MOF material of claim 1, wherein the UiO-66 present in the UiO-66-X MOF is connected to the X via a silicate bond (—O—Si—).

12: A method for capturing carbon dioxide directly from a CO₂-containing gaseous composition, comprising:
contacting and passing the CO₂-containing gaseous composition through particles of the MOF material of claim 1, thereby adsorbing at least a portion of CO₂ from the CO₂-containing gaseous composition onto surfaces of the MOF material particles and forming a purified gas composition.

13: The method of claim 12, wherein the CO₂ is present in the CO₂-containing gaseous composition in an amount of 0.01 to 5 wt. % based on a total weight of the CO₂-containing gaseous composition.

14: The method of claim 12, wherein the CO₂-containing gaseous composition further comprises at least one gas selected from the group consisting of hydrogen, nitrogen, oxygen, argon, helium, neon, xenon, and krypton.

15: The method of claim 12, wherein the CO₂-containing gaseous composition comprises CO₂ and N₂, and wherein the MOF material has a Henry's Law selectivity for CO₂ over N₂ of about 160.

16: The method of claim 12, wherein the purified gas composition is substantially free of CO₂.

17: The method of claim 12, further comprising:
preparing the MOF material by:
mixing a UiO-66-(OH)₂ MOF, an aminosilane compound and an organic solvent to form a mixture;
heating the mixture thereby reacting hydroxyl functional group of the UiO-66-(OH)₂ MOF with alkoxysilane functional group of the aminosilane compound to form the MOF material in the mixture;
separating the MOF material from the mixture by centrifuging, washing and drying.

18: The method of claim 17, wherein the aminosilane compound is at least one of (3-aminopropyl)trimethoxysilane, (3-aminopropyl)triethoxysilane, (3-aminopropyl)methyl dimethoxysilane and (3-aminopropyl)methyldiethoxysilane.

19: The method of claim 17, wherein a molar ratio of UiO-66-(OH)₂ MOF to aminosilane compound is in a range of 1:2 to 1:6.

20: The method of claim 17, wherein the organic solvent is ethanol.
